(19) United States
(12) Patent Application Publication
(10) Pub. No.: US 2003/0018725 A1
(43) Pub. Date: Jan. 23, 2003

(54) System and method for using an instant messaging environment to establish a hosted application sharing session

(76) Inventors: Tod Turner, Lake Forest Park, WA (US); Bruce Bequette, Lynnwood, WA (US); Wade Lance, Kirkland, WA (US); Bryan Schremp, Bothell, WA (US)

Correspondence Address: REED SMITH LLP, 2500 ONE LIBERTY PLACE, 1650 MARKET STREET, PHILADELPHIA, PA, 19103, US

(21) Appl. No.: 10/015,077

(22) Filed: Oct. 26, 2001

Related U.S. Application Data
(60) Provisional application No. 60/242,395, filed on Oct. 20, 2000.

(51) Int. Cl. G06F 15/16

(52) U.S. Cl. 709/206; 709/228

(57) ABSTRACT

The present invention is a system and method for using an instant messaging environment to facilitate the establishment of hosted application sharing sessions between a hosted application user and one or more other users in an instant messaging environment. The present invention utilizes a real-time instant messaging system to communicate necessary information between two messaging clients, allowing conditional limitations to be applied to the application sharing process, as well as providing a simplified method to allow shared application users to collaborate in a hosted application session.

### FIELD OF THE INVENTION

The present invention relates generally to a method for initiating an application sharing session between users in an instant messaging environment, and more particularly to using instant messaging protocols to communicate parameters for sharing a hosted application session.

### BACKGROUND

The following definitions are provided to more readily describe the present invention, and are not intended to limit the scope of the claims:

Access Authorization is the means by which a user's connection and request for service is authenticated and the user is permitted to access the service. There are many ways to authenticate a user, including a sign on ID and password, digital signature, electronic keycard, biometric device, etc. Once the authentication is performed, permissions may be checked to determine authorization for the request. In a secure system these connections may be usually encrypted.

A Network Access Device (hereafter “NAD”) is any device capable of communicating over a network to one or more other Network Access Devices using a common protocol. Such NADs can include but are not limited to computers, servers, workstations, Internet appliances, terminals, hosts, personal digital assistants (hereafter “PDAs”), cellular telephones, etc.

An Application Sharing Session is defined as an application that is being accessed by two or more Network Access Devices, wherein all Network Access Devices display a common application display.

Encryption is the transformation of data into a form that is unreadable without requisite knowledge (a key; see below). Its purpose is to ensure privacy by keeping information hidden from anyone for whom it is not intended to access the information, even those who have access to the encrypted data.

Decryption is the reverse of encryption; it is the transformation of encrypted data back into a tangible form. Encryption and decryption generally require the use of some secret information, which may be referred to as a key.

A Hosted Application is an application being executed on a host and accessed by a remote Network Access Device.

A Hosted Application Session is a session of use of a Hosted Application.

A Shared Application Session is defined as a Hosted Application Session that is being concurrently accessed by more than one network access device.

Client-server computing allows distributed systems to access and transfer information via communication protocols. The Internet and many private networks use the TCP/IP suite of protocols for clients and servers to identify and locate remote systems and then establish communication sessions with those systems. A popular example of a TCP/IP network is the World Wide Web, which is a network of systems that use web servers and web browsers to move HTML documents and other content in a classic or distributed client-server model. Many business software applications require heavy data processing, which can require large amounts of data to be moved between the client and server computers. Bandwidth restrictions, upgrade costs, maintenance costs and other factors make the distributed client-server application model inappropriate for some environments, and have led to the adoption of server-based computing systems.

### The Server-Based Computing Model

In a server-based computing model, software applications are installed, maintained and supported on centrally located servers, referred to as application servers. Users access and interact with that software across a network or dialup connection using a “thin” client. In the thin client model, all of the application processing happens on the server(s), and only user interface updates in the application are sent to the user's workstation. The input from users, including mouse movements, click events and keystrokes are captured at the users workstation and transmitted to the server where they are then passed to the target application. Application interface updates are then sent back to the client workstation for display. This process makes an application running on a remote server appear to the user as if it is running on the users workstation.

Citrix™ Independent Computing Architecture (ICA™) technology is one example of server-based computing. Users running Citrix ICA™ client software can access Citrix™ application servers. Users may then access software applications on those servers from their workstations in a server based computing model. The applications can be presented as a full graphical user interface (commonly referred to as a “desktop”) where the user has access to multiple simultaneous applications within the current session, as a published application where the user has access to just the single application that was published, or as a seamless window, where the application window is integrated into the environment of their local workstation, and the details of the application running on a remote server are hidden from the end user. Citrix ICA™ technology allows both the client and server components of client-server software applications to be loaded on Citrix application servers.

Microsoft Terminal Services™ is another example of server-based computing. Like the previous example, both the client and server components of legacy client-server software applications may be loaded on Microsoft Terminal Server™ application servers. Users may then access those applications from their workstations in a server based computing model. The applications can be presented as a full desktop where the user has access to multiple simultaneous applications within the current session, or as a published application where the user has access to just a single application that was published.

Yet another example would be a shared X-Windows application or desktop in a Unix™ or Linux™ environment. While hosted application sharing can be a useful tool, it may also raise security concerns for the shared environment.

### Network Security Concerns

The state of network security, in particular as it relates to the Internet, forces many companies and individual users to implement security systems between their private network and the public Internet in order to protect their computers from malicious use by computer “hackers”, and from computer viruses, worms, and other harmful activity. These security systems are generally referred to as firewalls and take many forms in both hardware and software. They may be stateless packet filters that simply block all activity to or from a specific Internet Protocol (hereafter “IP”) address or IP port. An IP port is a sub-address of a full IP address. IP ports allow more than one connection to the same IP address for different uses. For example, an email system might communicate on one port for incoming server-to-server traffic, and use a different port for incoming user to server traffic. Firewalls may also be statefull systems that analyze the content of the packets and the context in which they are being transmitted to decide whether the packet should be allowed. They may be implemented as software loaded on a server, software loaded on a users workstation, dedicated hardware systems designed to handle high volumes of traffic, or some combination of devices. While these systems provide a much needed buffer between public and private networks, they can also interfere with the ability of software running on a client network to access systems on a public network by restricting access or prohibiting access completely.

### Instant Messaging & IP Networks

Instant messaging (hereafter “IM”) systems employ a client-server model on IP networks to deliver text chat and other information to distributed user's in real-time. Instant Messaging client software may be loaded onto a users workstation, and may allow a user to log into a remote Instant Messaging server. Once a user has logged in, business rules may be used to determine which other users are available to communicate with the first user in the instant messaging system. Many IM systems allow users to create lists of other users that they commonly communicate with. When a user in such a list logs into the IM system, the server informs the list owner that a user on their list has logged on and is available to chat. In addition, Instant Messaging systems may provide directory services that permit users to search for other users. Once a user has the address of a second user, the first user can request a collaborative chat session with the second user. The second user can choose to either accept or reject the chat session. After the session has been accepted, the users may be able to communicate in a private or public chat session by typing text messages to one another. The message can be either transmitted through the IM system, or directly between users (peer to peer) once the first user has determined the availability of the second user from the IM system. These chat sessions may take place over an unsecured IP network.

### Application Sharing Across IP Networks

Most application sharing technologies use IP networks to establish the shared application sessions, and may therefore be restricted by firewall systems. In a Citrix™ environment, a Citrix ICA™ Shadow Session is the means by which one ICA™ session can be bound to one or more other ICA™ Sessions, allowing all ICA™ sessions to display the screen of the shadowed users session running on a Citrix™ application server. The shadow user may or may not be able to send keyboard and mouse input (hereafter referred to as “actively” participating) to the remote Citrix™ application server to control the application that is being viewed depending upon whether or not they are granted permission to do so. The shadow experience may be throttled for all users by the slowest connection to the session. The Citrix server may be configured to listen and respond to multiple IP ports simultaneously, allowing users behind a firewall more potential ways to connect to the server, provided they know the ports that the server is listening on.

In a Microsoft Windows Terminal Server™ environment, a hosted application session is established using the Microsoft RDP™ protocol, which uses a fixed IP port. From there, another user, with appropriate permissions, may take control of the application to allow multiple participants to show the hosted application.

### Traditional Access to Application Sharing Sessions

While hosted application sharing sessions provide a valuable service, the current state of the technology is limited in its ability to provide a secure, efficient or effective way for two or more users to locate each other and establish the application sharing session. The tools provided to initiate the application sharing session may not be user friendly, and may pose a security risk on a server if they enable users to access other functionality on the server, such as but not limited to: the ability to see a list of all active sessions on the server, the ability to enable or disable logons, the ability to shut down or reboot the server, the ability to install software, and other capabilities which pose a security risk. In addition, users may be impeded by firewalls or other site securing features, preventing their ability to establish a connection to the remote application server. Even if the application server has been configured to listen on multiple ports as a way to provide options to remote clients behind various firewall type devices or services, there are no client-based mechanisms that identify multiple ports and attempt to initialize an application sharing session across multiple ports.

### SUMMARY OF THE INVENTION

The present invention facilitates instant messaging users in sharing applications or desktops that are running in a hosted environment, such as Microsoft Terminal Server or a Citrix environment, by facilitating the selective initiation of an application sharing session with other instant messaging users, or by delivering other instant messaging users requests to share a hosted application.

The present invention may be embodied in a method for communicating hosted application information to allow sharing of a hosted application session. The method may include instantiating instant messaging client on a network access device engaged in a hosted application session, or on a network access device desiring to share an on-going hosted application session, and communicating from that network access device to a second access device a message indicating the desire to create a shared application session. The second network access device may be utilized to determine whether a it is desired or desirable to share the ongoing session, and communicate an acceptance or refusal of the requested sharing. The If the request is accepted, a communications path between the first and second network access devices may be utilized to communicate application sharing information to enable a hosted application session to be shared.

The present invention may alternately be embodied in a method which further includes the network access device of a user engaged in a hosted application session a request to transmit an invitation to share a session to a second network access device. Alternately, a request to be allowed to share a session can be generated at a network access device that is not engaged in a hosted application session, with the request being sent to a network access device engaged in a hosted application session.

The present invention may be embodied in a support service for a hosted application, wherein an accessor of the hosted application can request sharing of an ongoing application session by support entity, wherein the accessor can generate a request via an instant messaging system to the support entity to have the support entity participate in an on-going hosted application session, allowing the support entity to assist the accessor.

### BRIEF DESCRIPTION OF THE DRAWINGS

The summarized description of illustrative embodiments of the present invention will be more fully understood upon a consideration of the following detailed description with reference to the attached drawings, wherein:

FIG. 1 is an illustrative flowchart showing the present invention embodied in a User-to-User application sharing session.

FIG. 2 is an illustrative flowchart showing possible details of a discovery and exchange process.

FIG. 3 is an illustrative flowchart showing possible details of a security process for hosted sharing applications.

FIG. 4 is an illustrative flowchart showing possible details of a port discovery process.

FIG. 5 is an illustrative flowchart showing possible details of a notification process for hosted application sharing requests.

FIG. 6 is an illustrative flowchart showing the present invention embodied in a support or “help-desk” embodiment.

FIG. 7 is an illustrative flowchart showing the present invention embodied in a sales presentation embodiment.

FIG. 8 is an illustrative flowchart showing the present invention embodied in a training environment embodiment.

FIG. 9 is an illustration showing an overview of system components, which may be used in an embodiment of the present invention.

### DETAILED DESCRIPTION OF THE INVENTION

The various features and methods of this invention will now be described in the context of a collaborative hosted application sharing session, utilizing four illustrative embodiments thereof, including business collaboration, support, e-commerce sales, and training. Those skilled in the art will recognize that the inventions disclosed may also be used to begin shared sessions for a broad range of purposes. By way of example and not limitation, the disclosed methods can also be used to implement business-to-business collaboration, personal collaboration among friends, medical collaboration among doctors, and a wide variety of other implementations. Further, these methods may be implemented as a service for public consumption, or packaged as a software product that may be installed at a consumer site for private use, such as an internal intranet or private network.

Throughout this description, reference will be made to various implementation-specific details of illustrative collaboration environments, operating systems or platforms, instant messaging systems, the Citrix ICA™ Protocol, Microsoft RDP™ Protocol, and the sited embodiments. These details are provided in order to illustrate embodiments of the invention, and not to limit the scope of the invention. The scope of the invention is set forth in the appended claims.

The instant messaging environment provides a convenient, efficient platform for two or more users to come together in a collaborative way. It offers mechanisms for users to locate other users, determine their availability, and collaborate with one another in private or public text chat. By including environment discovery and capability exchange in an instant messaging environment, this invention assists users in easily engaging in hosted application sharing sessions.

Environment discovery is the discovery of the operating environment of the network access device, including but not limited to the operating system, hardware and software components, network connectivity, etc. Network access device capability may be determined as a result of the environment discovery process.

Capability exchange may include, but is not limited to, the type of application sharing, a sharing protocol, and port availability information that the application server is listening on for incoming connections. This information allows instant messaging software to attempt a basic connect sequence. If a port is found that allows the correct connect sequence, then the attempt may be terminated, and software features may be enabled to allow initiation of remote application sharing sessions. If none of the ports in the list can be successfully negotiated, it may be presumed that a firewall or some other networking issue is blocking the connection, and the application sharing launch features may be disabled for this user in this instant messaging session.

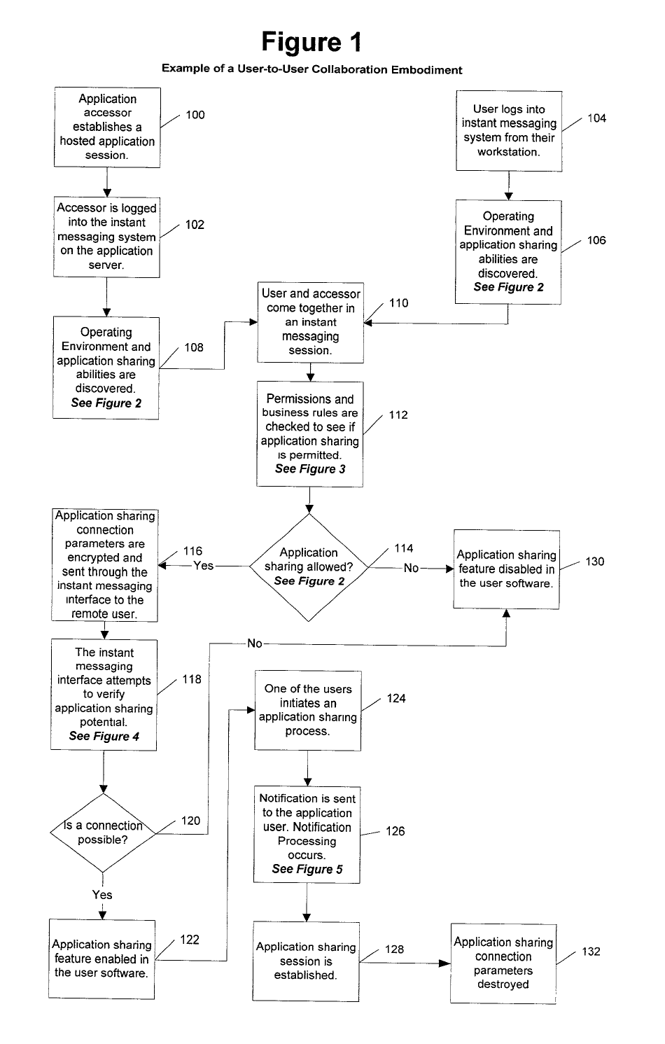

In a first embodiment of the present invention, as shown in FIG. 1, two or more coworkers or cross-organization project participants may collaborate on a joint project. A first user who is accessing a session of a hosted application (an “accessor”) may instantiate an instant message session with a desired participant. Application sharing capabilities may be communicated from the accessor to the desired participant through the IM session. Additionally, an accessor in a hosted session could be able to invite other participants to join them in an application sharing session. Communication of the necessary application sharing parameters to the invited participants may be accomplished through the instant messaging software. The invited participant could receive notification of the invitation, and could accept the invitation, causing an application sharing session to be attempted. If the connection attempt were successful, the users would be joined in an application sharing session. Alternately, a minimal application sharing session could be attempted prior to the invitation being communicated to the invited participant.

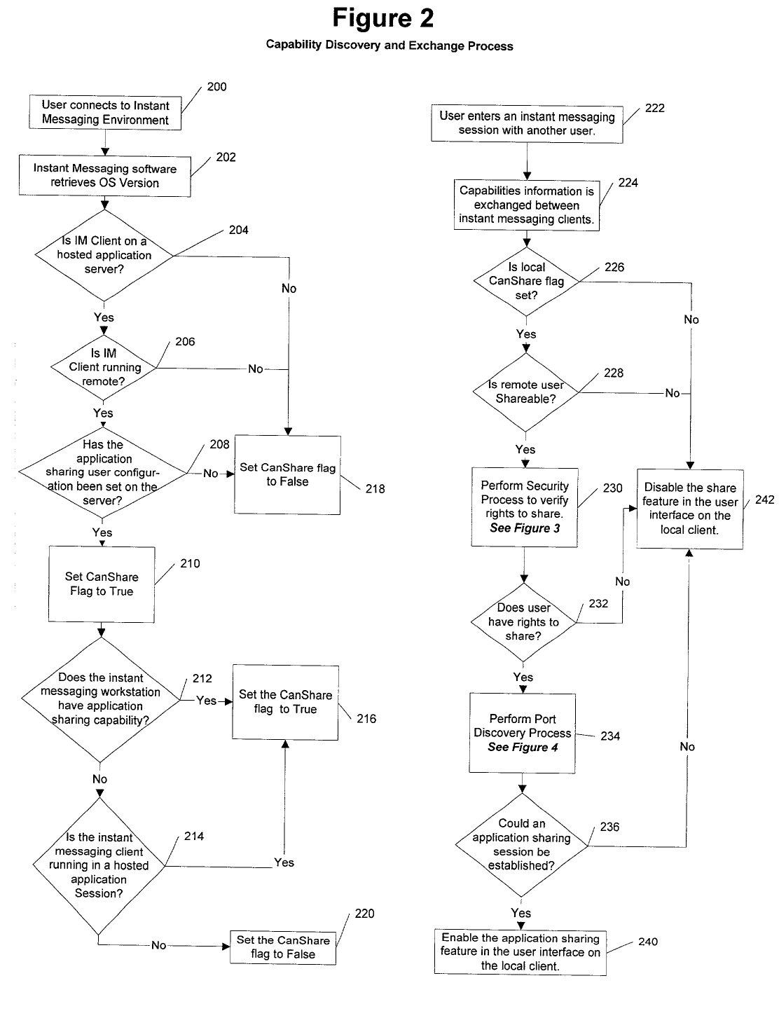

FIG. 1 details a process wherein a shared hosted application session between two participants is established according to the present invention. The arrows in the figures show the general flow of a process that may occur, though the exact sequence may vary due to implementation details, business requirements, or other reasons. As illustrated by FIG. 1, an accessor establishes 100 or is already established in a hosted application session. The server used to deliver the hosted application session may be any platform capable of supporting the remote application protocol in use, such as but not limited to being Citrix ICA® based, Microsoft RDP based, Unix/Linux X-Windows based, etc. The instant messaging application may either be running locally on the accessors network access device 104 or it may be running on the remote application server and delivered to the accessor in their hosted application session 102. If operating within the hosted session, the instant messaging environment may be either manually or automatically launched 102. Instant messaging software may take many forms, ranging from published standards based systems such as Internet Relay Chat (IRC) to proprietary messaging environments like America Online Instant Messenger and others. Instant messaging systems may provide presence tracking and rapid communication between two or more users. When the instant messaging software starts, an environment discovery process 108 may be performed. Such a discovery process is shown in FIG. 2. FIG. 2 details the environment discovery process. As shown, the Operating System (hereafter “OS”) type and version information may first be determined 202. If the OS supports remote users, 204 the session mode may be checked to see if the session is a remote session 206. The Session Mode may be defined as either Remote if the user is working from a separate network access device or Local if the user is working directly from a console directly connected to the host. A Remote session is any session initiated from a network access device other than the host. If the session is running as a remote session, the server may be checked to see if an application sharing user account has been configured for the server 208. If these conditions cannot be met, then the client may not be shareable 218. If these conditions are met, then the client may be potentially shareable 210. Next, the client software may check to see if client protocol software is installed 212 on the platform. If the client protocol software is present 212, or the client is running in a remote session 214, then a flag may be set indicating that the client can join another user in a shared application 216, otherwise, the flag may be cleared indicating that the client cannot join another user 220. In short, this information may be used to determine if application sharing is possible, and in which direction. This information may be cached for later use.

Returning to FIG. 1, when another instant messaging user 104 establishes a connection to the instant messaging system, their presence may be made known to the instant messaging system. Based upon rules configured in the instant messaging system and in the instant messaging clients of the instant messaging system, the presence of this new user may be shown or hidden from other users of the system. In addition, when the instant messaging software starts, an environment discovery process 106 may be performed. As discussed above, FIG. 2 details the environment discovery process.

At some point, a user of the instant messaging system may decide to collaborate with another user. The first user may locate the second user using the directory service provided by a instant messaging software to locate a user they wish to collaborate with. An invitation may be sent via the instant messaging software to the target user or users, and they may accept or reject the invitation. At the point they accept the invitation 110, an instant messaging session may be created, and all users may come together into the session to collaborate using text based chat and/or possibly voice/video chat. The method in which they chat may be determined by the capabilities of the instant messaging platform.

When an instant messaging session is established, the permissions of each user in the session may be verified 112 to see if they are permitted to initiate an application sharing session with another user, or if they are permitted to share hosted applications to remote users. If a user is permitted 114, the remote configuration information may be passed between the users in the session to determine the platform and ability of each user in the session.

As shown in FIG. 2, when a user enters an instant messaging session, a capabilities exchange may occur to see if that user and session is running as a remote session 224. First, the local share ability 226 may be determined by checking the ‘can share’ flag 216. If application sharing is supported locally 226, then the remote user capabilities may be checked to see if they can host an application sharing session 228. If the remote user can host an application sharing session 228, then a security process 230 may be performed to see if the application sharing session may be established according to permissions and business rules.

A variety of security features may be implemented, including encryption of the application sharing parameters that are passed between instant messaging clients and the destruction of those parameters after their use, and an opaque way of exposing the application sharing parameters to the instant messaging clients such that users do not see the actual commands, accounts, and passwords used to establish the session. This may allow an Application Server Administrator to configure accounts used to enable application-sharing sessions without publishing the details to the end users. If a user of the system is terminated, no security risk is present because the user was never shown the details necessary to establish the application sharing session. Since information may be fetched each time the user connects to the system, an administrator can maintain and change the accounts at any time without needing to notify the end users of the change. The next time a user connects to the system, new parameters will be used automatically.

An additional feature may be the ability to configure which users have permission to share hosted applications, the permitted direction of the application sharing session request (hosted user to remote user, remote user to hosted user, either, or neither), whether notification will be provided to a hosted user, and whether a hosted user must accept the request before the application sharing session may be instantiated. Existing settings for the application server software may be accommodated such that if notifications are enabled, a user may not be issued an application sharing request dialog twice, once from the instant messaging software, and once from application server.

An instant messaging system may be extended such that user settings, contact lists, preferences, and profiles may be stored on an instant messaging server. Such a process allows a user to connect from any NAD, or to any application server while seeing the same user settings, contact lists, preferences, and profile.

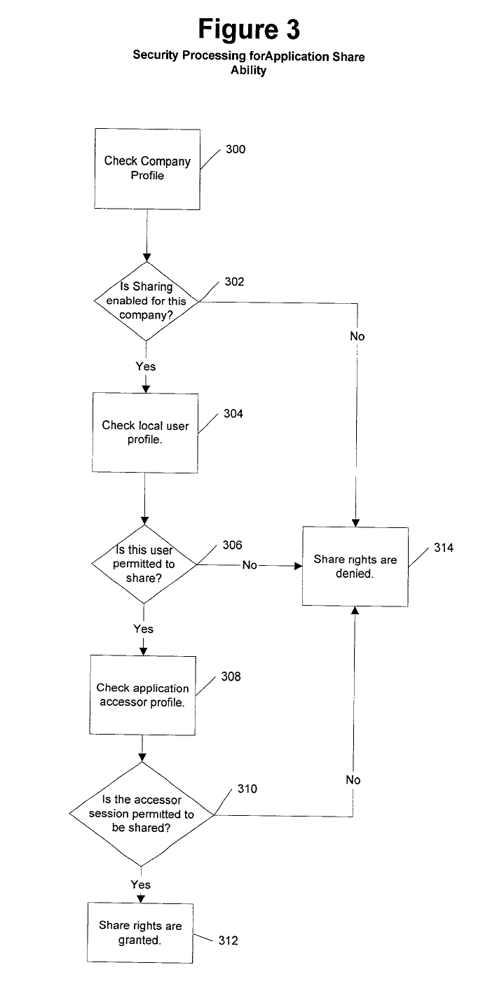

FIG. 3 shows details associated with a security process. First, a company profile 300 may be checked to see if the company permits application sharing 302. If application sharing is permitted, a local user profile may be checked 304 to see if the user may join another user's hosted application session 306. If local user is permitted to join the session of another user, then the remote user's profile may be checked 308 to see if users are permitted to share their application with them. If other users are permitted to join the session 310 then access rights may be granted 312. If any of these validations fail, then rights may be denied 314.

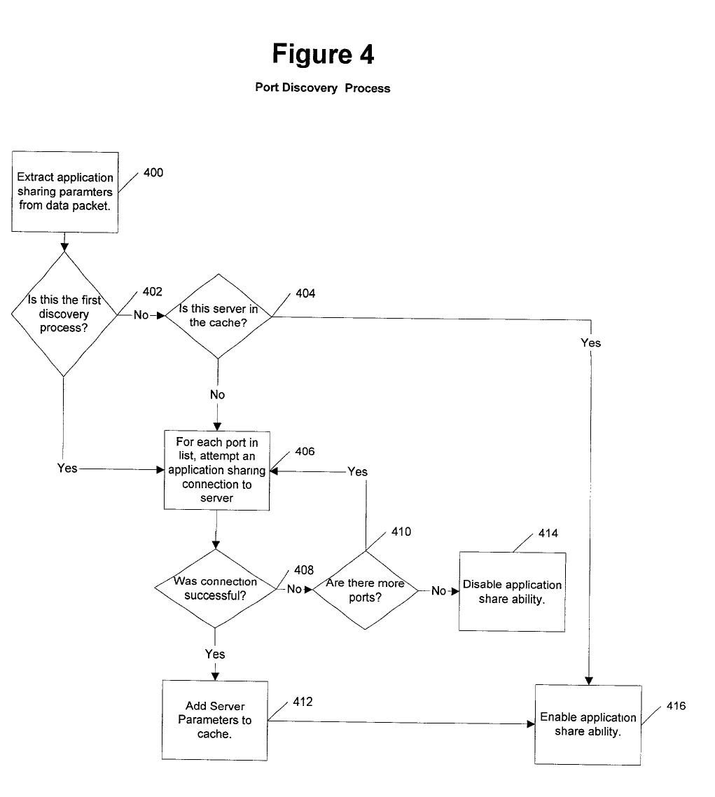

Returning to FIG. 2, if a user is denied rights to share an application 232, then the application sharing features may be disabled in the instant message client while that remote user is selected 242. If the user is granted rights to share the application 232, then the instant messaging client may perform the Port Discovery process 234 as described further below in FIG. 4. If the Port discovery process is successful, 236, then application-sharing features may be enabled in the instant message client while that remote user is selected 240.

Returning to FIG. 1, if a user has permission to join an application session another user, and has the application sharing client software installed on their NAD, then the instant messaging software may send a request to the accessor of the hosted application to retrieve the configured application sharing parameters. The hosted client may encrypt the application sharing parameters needed for establishing a session and transmit them through the instant messaging system 116 to the remote user. This

FIG. 3 illustrates details which may be associated with a security process. A company permits application sharing 302. If application sharing is permitted, a local user profile may be checked 304 to see if a first user may join another (second) user's hosted application session 306. If the first user is permitted to join the session, the second user's profile may be checked 308 to determine whether the second user is permitted to share a hosted application session. If sharing is permitted 310 then sharing rights may be granted 312. If any of these validations fail, sharing rights may be denied 314.

As shown in FIG. 2, if the second user second is denied rights to share an application 232 to a first user, then the application sharing features may be disabled in the instant message client while that first user is selected 242. If the second user is granted rights to share the application 232, then the instant messaging client may perform a port discovery process 234 as described further in FIG. 4. If the Port discovery process is successful, then application-sharing features may be enabled in the instant message client while that remote user is selected 240 upon affirmative establishment of an application sharing session 236.

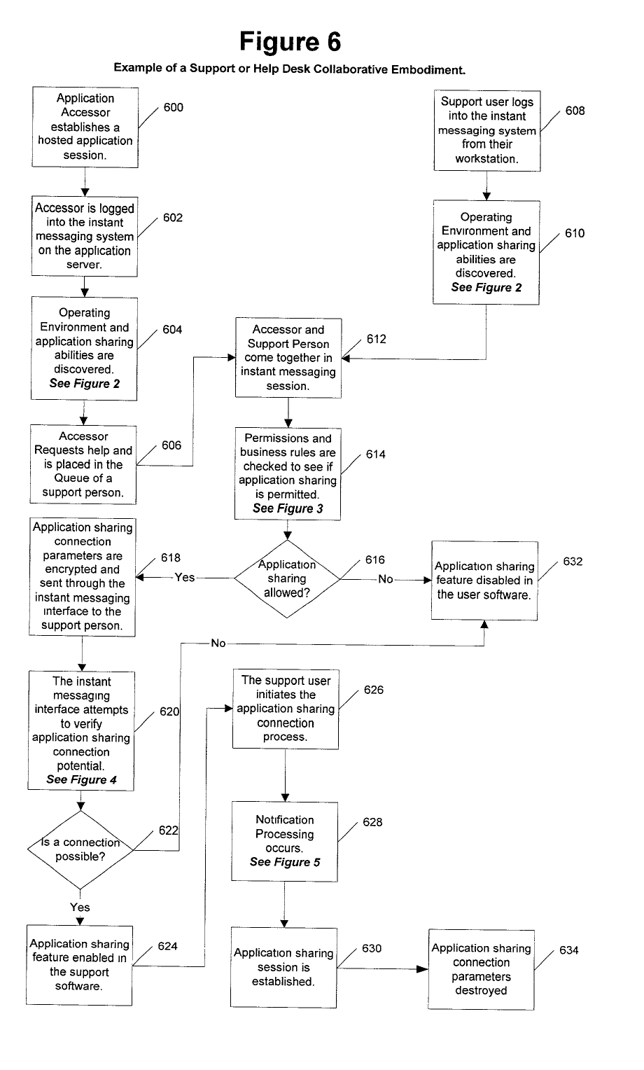

Returning to FIG. 6, if a support person has permission to initiate an application sharing session with a hosted application user, and has adequate application sharing client software installed on their NAD, then the instant messaging software may be used to send a request to the hosted application user to obtain the configured application sharing parameters. Parameter needed for establishing an application sharing session may be encrypted and transmitted through the instant messaging system 618 to the support users instant messaging client. This information may include a server address, session ID, list of ports that the server is listening on, user account, user password, screen settings, and other settings that may be necessary for establishing an application sharing session. When a support users instant messaging software receives this information, it may begin a background process of determining if the support user is able to connect to the remote user session 620.

In FIG. 6, a port discovery process is summarized in items 618, 620, 622, 624, and 632. A more full description of a port discovery process is described with regards to FIG. 4, discussed above. When the application sharing session is initiated 626, a notification process may be performed 628.

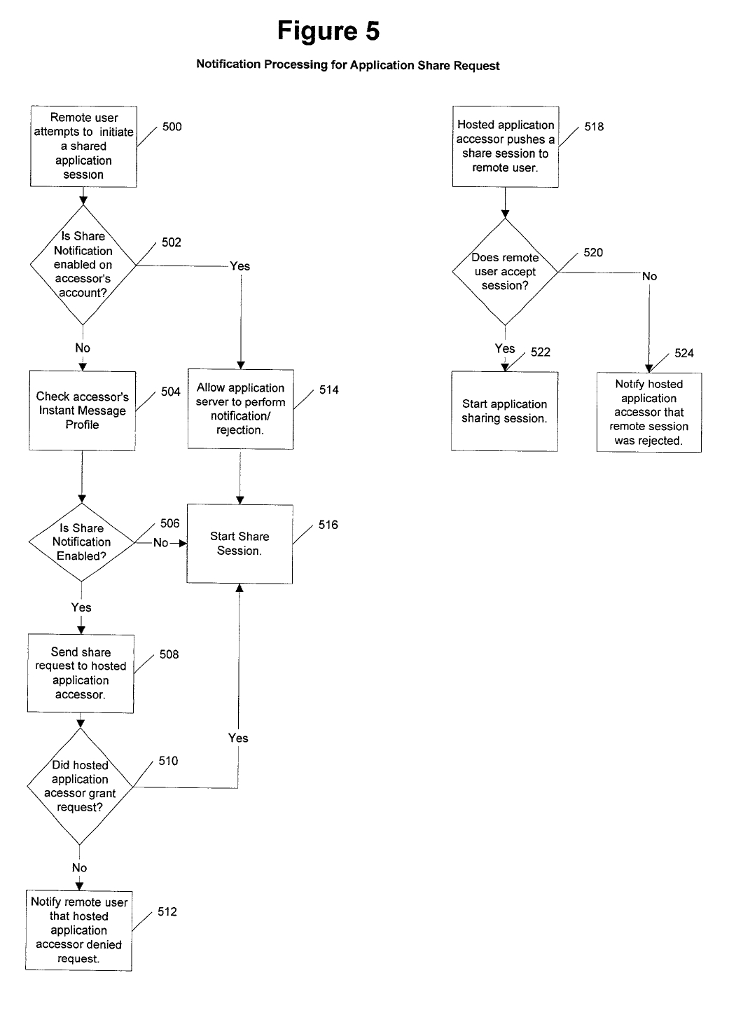

FIG. 5 shows details associated with notification process. If a remote user initiates an application-sharing request 500, a notification feature built into the application server may be checked to determine if notification is enabled for user account. If the notification is enabled 502, the application server may perform a normal notification and or rejection process 514. If the application server notification is not enabled, then the settings of the user profile in the instant messaging system may be used to determine notification parameters 504. If application-sharing notification is enabled 506, then an application-sharing request may be sent to the user of the hosted application 508. If the hosted user accepts the request 510, or if application-sharing notification is not enabled 506, then the application sharing session may be established without further delay 516. Otherwise, the remote user may be notified that the hosted user denied the request 512, resulting in the application sharing session not being initiated.

If a hosted user “pushes” an application-sharing invitation to a remote user 518, the remote user may be given the opportunity to accept the session invitation 520. If the user accepts the invitation, the session may be started 522. If the user rejects the invitation, then the hosted user may be notified that the remote session was rejected 524.

In FIG. 6, this notification process and session establishment is summarized in items 628 and 630. The final process in establishing the application sharing session may include destroying the connection parameters used to create the session 634. This action ensures that the connection parameters are not left on a user's system where they could be exploited for inappropriate or unauthorized activities.

In another embodiment of this method, a user may be connected to a hosted application for purposes of a demonstration. When that user connects to the hosted application, they could be placed in an instant message session, which could notify a sales person that a user was viewing their software in real-time. In addition, the application sharing parameters could be communicated from the user session to the sales person's instant messaging interface seamlessly in the background, allowing the instant messaging interface time to determine the feasibility of establishing an application sharing session. The sales person could engage the user in instant text messaging, and offer to demonstrate the application to the user. If the user agrees, the sales person could initiate the application sharing session and ‘walk’ the user through the features of the hosted application, thereby increasing the effectiveness of the demonstrator's presentation.

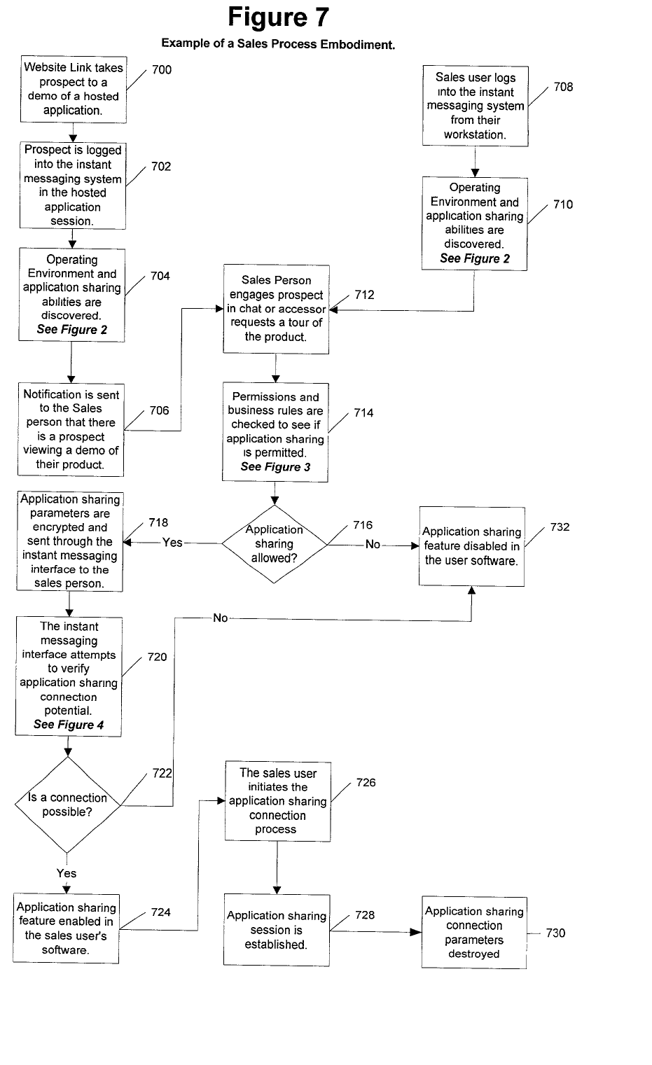

FIG. 7 details such an embodiment. The sales person may use the collaborative environment to proactively assist the customer with the demonstration, answer questions interactively, and highlighting the features of the application. As illustrated in FIG. 7, a user may establish 700 or already be established in a hosted application session that may be running a demonstration. While operating within the hosted application session, the instant messaging environment may be automatically launched 702. When the instant messaging software starts, an environment discovery process 704 may be performed.

When a sales person 708 establishes a connection to the instant messaging system, their presence may be made known to the instant messaging system. Based upon rules configured in the instant messaging system and in the instant messaging clients of the instant messaging system, the presence of this new user may be shown or hidden from other users of the system. In addition, when the instant messaging software starts, an environment discovery process 710 may be performed.

When a prospect enters a hosted environment for a demonstration, a sales person may be notified of the presence 706. Either the prospect or the sales person may initiate collaboration. If the prospect initiates collaboration, the request may be queued up for an available sales person. If a sales person initiates collaboration, instant messaging may begin immediately. An instant messaging session may be created 712, bringing the prospect and the sales person together into an IM session to collaborate using text based chat or voice/video chat. The method in which they chat may be determined by the capabilities of the instant messaging platform.

Once an instant messaging session is established, permissions of the prospect and the sales person in the session may be verified 714 to see if they are permitted to initiate a remote application sharing session. If permitted 716, remote configuration information may be passed between the NAD's of the prospect and the sales person in the session to determine the platform and ability of each NAD.

In FIG. 7, if a sales person has permission to share the hosted application of a prospect, and has sufficient application sharing client software installed on their NAD 716, then the instant messaging software may send a request to the prospect that is hosted to retrieve the application sharing parameters. The hosted prospects instant messaging client may encrypt the application sharing parameters needed for establishing a session and transmit them through the instant messaging system 718 to the sales person. This information may include the server address, session ID, list of ports that the server is listening on, user account, user password, screen settings, and other settings that may be necessary for establishing an application sharing session. When the sales person's instant messaging software receives this information, it may begin a background process of determining if the sales person is able to connect to the hosted application server 720.

In FIG. 7, a port discovery process is summarized in items 718, 720, 722, 724, and 732. If application sharing is feasible, the application-sharing launch features may become enabled in the instant messaging software. The sales person may then initiate an application sharing session 726 to assist the prospect interactively during the sales process 728. In this manner, a personal touch is brought to the sales process in an e-commerce environment. The final process in establishing such an application sharing session may include destroying the connection parameters used to create the session 730. This action ensures that the connection parameters are not left on a sales persons system where they could be exploited for inappropriate or unauthorized activities.

In another embodiment, a trainer may host a moderated training session with one or more users. The trainer could invite the trainees to a moderated instant messaging session, then push the hosted application sharing parameters through the instant messaging system to the trainees' instant messaging client. The instant messaging client could receive the command and begin the process of connecting each of the trainees to the instructor's hosted application session via an application sharing capability. As each trainee is joined to the session, a user status indicated by the instant messaging system could be updated to show whether the trainee is connected read-only or interactively to the trainers session. Requiring users that participate in the application sharing session to use NAD's meeting minimum bandwidth, screen resolution, and other performance requirements before a session is established may further enhance the training experience by minimizing delays inherent in the use of slower equipment. The status of users that failed to connect due to a performance restriction could be indicated in the trainer's instant messaging software such that the trainer knew the reason and could either reduce the requirements, thereby allowing the user to join the session, or explain to the trainee that they will have to reschedule the training.

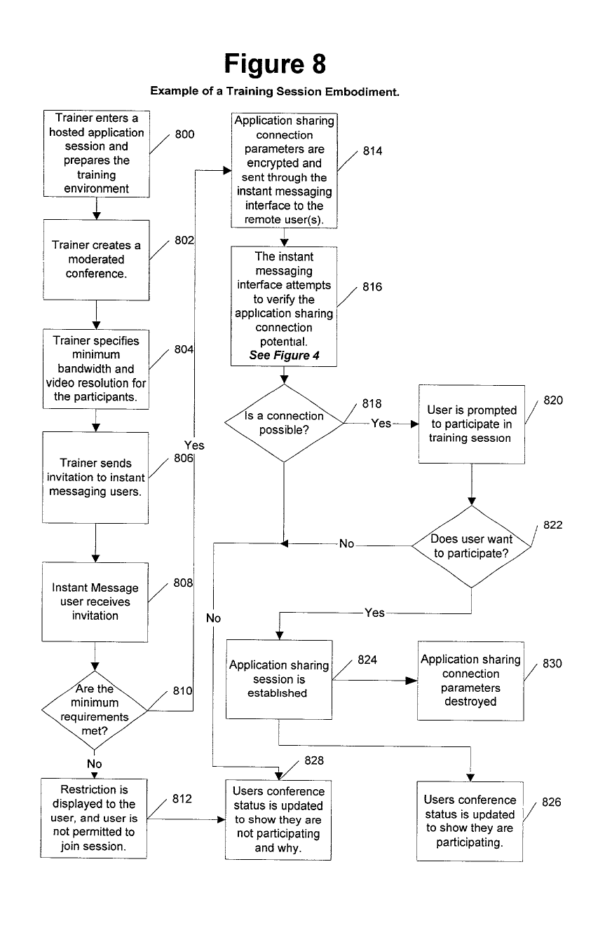

FIG. 8 details such an embodiment in which a trainer hosts an interactive training session for one or more users in a hosted application environment. The trainer may use the collaborative environment to create a moderated training session for the students. The trainer may first enter a hosted application environment and prepare it for the training session 800, thus ensuring that the application is configured correctly. Once the environment is configured, the trainer may create a moderated conference in the instant messaging platform 802. The trainer may specify the minimum requirements for participants in the training session 804, which may include the video resolution and bandwidth.

The affect that the performance characteristics of a NAD have on a shared hosted application session is driven by the poorest capability of a sharing NAD in the environment. If one NAD is connected via a slow network connection, each other participant in the session must await while communication on the slowest network connection is completed. Alternately, a NAD having sub-standard graphics capability may result in a hosted application session being generated at a low resolution to accommodate the NAD having sub-standard graphics, or alternately being generated at full resolution, requiring a user of the NAD to continuously scroll around a display, delaying the users participation in a collaborative session. Other parameters, such as whether a display is presented in color, whether a processor or memory limitation of a NAD adversely effects the pace of the session, or whether a particular NAD has audio capability can adversely impact the collaborative nature of a shared application session, thus creating an incentive to limit participation of such a sub-standard NAD during a session.

Once the environment has been setup, the trainer may send an invitation to desired participants, allowing them to join the moderated conference 806. The instant messaging system may forward the invitations to each participant. When a desired participant's instant messaging client receives the invitation, 808, it may first check the minimum requirements 810 to see if the NAD on which it is resident will be permitted in the conference. If the NAD does not meet the minimum requirements, the reason for the restriction may be displayed to the desired participant 812, and the user's conference status may be updated to indicate that they are not participating in the conference. The reason for the users non-participation may be included in status information that is available to the trainer, allowing the trainer to reduce the minimum requirements, and resend the invitation to the failed desired participants if desired.

If the minimum requirements were met, the application sharing parameters may be encrypted and may be sent to the remote trainees' NADs 814. When the instant messaging client receives this information, it may begin a process to verify application sharing potential 816.

If a port discovery process results in a determination that no valid port was located 818, a user may be notified, and their conference status updated to show that they are not participating in an application sharing session 828. If a user can participate in the application sharing session, they may be prompted to join the training session 820. If a user chooses to participate 822, the application sharing session may be launched, 824, and the user's conference status updated to show that they are now participating 826. The final process in establishing the application sharing session may include destroying the connection parameters used to create the session 830. This action ensures that the connection parameters are not left on a user's system where they could be exploited for inappropriate or unauthorized activities. If the user chooses not to participate 822, the users conference status may be update to show they are not participating, and the reason may be set to indicate the user declined to participate 828.

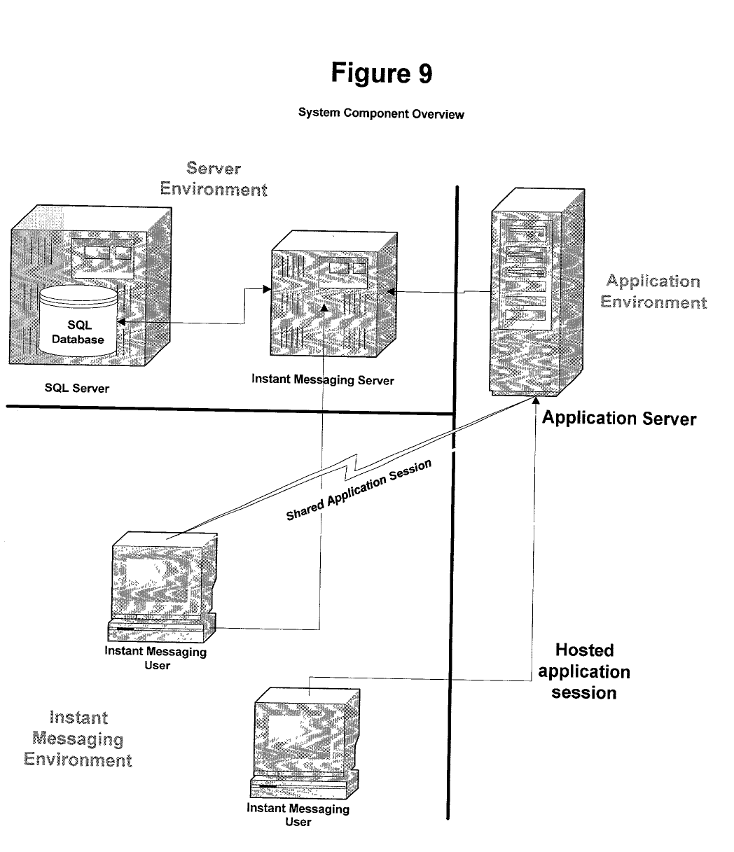

From the foregoing teachings, it can be appreciated that a new, novel and non-obvious method for establishing hosted application sharing sessions using an instant messaging environment has been disclosed. For reference, FIG. 9 is provided as an example system component overview which may be used in an embodiment of the present invention. It is to be understood that numerous alternatives and equivalents will be apparent to those of ordinary skill in the art, given the teachings herein, such that the present invention is not to be limited by the foregoing description but only by the appended claims.

What is claimed is:

1) A method for communicating hosted application information to allow sharing of a hosted application session, comprising the steps of:
instantiating a first instant messaging client on a first network access device, said first network access device being remote from a hosted application server, said first network access device participating in a hosted network application;
establishing a communications path from the first network access device to a second network access device, said second network access device running a second instant messaging client, said second instant messaging client being communicably connected to said first instant messaging client via a network, said communications path for communicating information using an instant messaging protocol between the first and second network access devices; and
using an instant messaging protocol to communicate hosted application information to the second network access device, said information comprising parameters for sharing the hosted application session being participated in by the first network access device.

2) A method for communicating hosted application information to allow sharing of a hosted application session according to claim 1, wherein said hosted application information comprises port information for accessing a hosted application session to be shared.

3) A method for communicating hosted application information to allow sharing of a hosted application session according to claim 1, wherein said hosted application information comprises protocol information for accessing a hosted application session to be shared.

4) A method for communicating hosted application information to allow sharing of a hosted application session according to claim 1, wherein said hosted application information comprises access authorization information for accessing a hosted application session to be shared.

5) A method for communicating hosted application information to allow sharing of a hosted application session according to claim 1, wherein said hosted application information is masked to prevent said information from being readily discernible by a user of the first or second network access device.

6) A method for communicating hosted application information to allow sharing of a hosted application session comprising the steps of:
instantiating a first instant messaging client on a first network access device, said first network access device being remote from a hosted application server, said first network access device participating in a hosted network application;
establishing a communications path from the first network access device to a second network access device, said second network access device running a second instant messaging client, said second instant messaging client being communicably connected to said first instant messaging client via a network; and
receiving a request to issue an invitation from the first network access device to the second network access device, said invitation inviting a user of the second network access device to participate in a shared hosted application session through the second network access device.

7) A method for communicating hosted application information to allow sharing of a hosted network application session according to claim 6, further comprising the step of determining whether a hosted application is shareable before issuing an invitation to the second network access device.

8) A method for communicating hosted application information to allow sharing of a hosted network application session according to claim 7, wherein the step of determining whether a hosted application session is shareable comprises determining whether the hosted application server is capable of supporting a shared hosted application session.

9) A method for communicating hosted application information to allow sharing of a hosted network application session according to claim 6, further comprising the step of determining whether the second network access device is capable of participating in a shared hosted application session before allowing an invitation to be communicated to the second network access device.

10) A method for communicating hosted application information to allow sharing of a hosted network application session according to claim 9, wherein the step of determining whether the second network access device is capable of participating in a shared hosted application session comprises determining whether the second network access device has compatible hosted application sharing software installed.

11) A method for communicating hosted application information to allow sharing of a hosted network application session according to claim 9, wherein the step of determining whether the second network access device is capable of participating in a shared hosted application session comprises determining whether the second network access device is able to access the hosted application server in accordance with hosted application information communicated to the second network access device.

12) A method for communicating hosted application information to allow sharing of a hosted network application session according to claim 11, wherein the step of determining whether the second network access device is able to access the hosted application server comprises instantiating a server access attempt from the second network access device to the hosted application server to determine whether the second network access device is capable of communicating with a port on a hosted application server in accordance with the hosted application information.

13) A method for communicating hosted application information to allow sharing of a hosted network application session according to claim 6, further comprising the step of determining whether a network access device should be invited to share a hosted application session, said determination being dependant upon the performance capability of the network access device.

14) A method for communicating hosted application information to allow sharing of a hosted network application session according to claim 13, wherein the determination is dependant upon a graphical display resolution of the network access device.

15) A method for communicating hosted application information to allow sharing of a hosted network application session according to claim 13, wherein the determination is dependant upon the bandwidth of the network connection between the network access device and the hosted application server.

16) A method for communicating hosted application information to allow sharing of a hosted application session according to claim 6, further comprising the step of communicating hosted network application information to the second network access device, wherein said hosted network application information is masked to prevent said information from being readily discernible by a user of the second network access device.

17) A method for communicating hosted application information to allow sharing of a hosted application session according to claim 16, wherein said hosted application information is encrypted while being communicated to the second network access device.

18) A method for communicating hosted application information to allow sharing of a hosted application session according to claim 16, wherein said hosted application information comprises access authorization information.

19) A method for communicating hosted application information to allow sharing of a hosted application session according to claim 16, wherein said access authorization information is unique to a hosted application sharing session.

20) A method for communicating hosted application information to allow sharing of a hosted application session according to claim 16, wherein said hosted application information is communicated to said second network access device via said first network access device, and further wherein said hosted application information is masked to prevent said information from being readily discernible by a user of the first network access device.

21) A method for communicating hosted application information to allow sharing of a hosted application session according to claim 6, wherein said hosted application information comprises role information for defining a participants authority to interact with a shared hosted application.

22) A method for communicating hosted application information to allow sharing of a hosted application session according to claim 21, wherein said role information may be used to alternate control of a shared hosted application session between a first network access device and a second network access device.

23) A method for communicating hosted application information to allow sharing of a hosted application session according to claim 21, wherein a user is associated with a network access device, said user having an identity, and wherein said role information is dependant on the identity of the user.

24) A method for communicating hosted application information to allow sharing of a hosted application session comprising the steps of:
instantiating a first instant messaging client on a first network access device, said first network access device being remote from a hosted application server, said first network access device participating in a hosted network application;
establishing a communications path from a second network access device to the first network access device, said second network access device having a second network connection, said network connection having a band width, said second network access device further running a second instant messaging client, said second instant messaging client being communicably connected to said first instant messaging client via the network connection, said communications path for communicating hosted application information using an instant messaging protocol between the first and second network access devices; and
receiving at the first network access device a request from the second network access device, said request requesting communication of hosted network application information to the second network access device to allow the second network access device to participate in a shared hosted application session.

25) A method for communicating hosted application information to allow sharing of a hosted network application session according to claim 24, further comprising the step of determining whether a hosted application can be shared before communicating hosted application information to the second network access device.

26) A method for communicating hosted application information to allow sharing of a hosted network application session according to claim 25, wherein the step of determining whether a hosted application session can be shared comprises determining whether the hosted application server is capable of supporting a shared hosted application session.

27) A method for communicating hosted application information to allow sharing of a hosted network application session according to claim 25, further comprising the step of determining whether the second network access device is capable of participating in a shared hosted application session before communicating hosted application information to the second network access device.

28) A method for communicating hosted application information to allow sharing of a hosted network application session according to claim 27, wherein the step of determining whether the second network access device is capable of participating in a shared hosted application session before communicating hosted application information to the second network access device comprises determining whether the second network access device has compatible hosted application sharing software installed.

29) A method for communicating hosted application information to allow sharing of a hosted network application session according to claim 27, wherein the step of determining whether the second network access device is capable of participating in a shared hosted application session before communicating hosted application information to the second network access device comprises determining whether the second network access device is able to access the hosted application server in accordance with hosted application information communicated to the second network access device.

30) A method for communicating hosted application information to allow sharing of a hosted network application session according to claim 29, wherein the step of determining whether the second network access device is able to access the hosted application server comprises instantiating a server access attempt from the second network access device to the hosted application server to determine whether the second network access device is capable of communicating with a port on a hosted application server in accordance with the hosted application information.

31) A method for communicating hosted application information to allow sharing of a hosted network application session according to claim 24, further comprising the step of determining whether hosted application information should be communicated to the second network access device in response to a request, said determination being dependant upon the performance capability of the second network access device.

32) A method for communicating hosted application information to allow sharing of a hosted network application session according to claim 31, wherein the determination is dependant upon the graphical display resolution of the network access device.

33) A method for communicating hosted application information to allow sharing of a hosted network application session according to claim 31, wherein the determination is dependant upon the bandwidth of the second network connection.

34) A method for communicating hosted application information to allow sharing of a hosted application session according to claim 24, further comprising the step of communicating hosted application information to the second network access device, wherein said hosted application information is masked to prevent said information from being readily discernible by a user of the second network access device.

35) A method for communicating hosted application information to allow sharing of a hosted application session according to claim 34, wherein said hosted network application information is encrypted while being communicated to the second network access device.

36) A method for communicating hosted application information to allow sharing of a hosted application session according to claim 34, wherein said hosted application information is communicated to said second network access device via said first network access device, and further wherein said hosted application information is masked to prevent said information from being readily discernible by a user of the first network access device.

37) A method for communicating hosted application information to allow sharing of a hosted application session according to claim 34, wherein said hosted application information comprises access authorization information.

38) A method for communicating hosted application information to allow sharing of a hosted application session according to claim 37, wherein said access authorization information is unique to a hosted application sharing session.

39) A method for communicating hosted application information to allow sharing of a hosted application session according to claim 24, wherein said hosted application information comprises role information, said role information defining the authority of a network access device to interact with a shared hosted application.

40) A method for communicating hosted application information to allow sharing of a hosted application session according to claim 39, wherein said role information is used to alternate control of a shared hosted application session between a first network access device and a second network access device.

41) A method for communicating hosted application information to allow sharing of a hosted application session according to claim 39, wherein a user is associated with a network access device, said user having an identity, and wherein said role information is dependant on the identity of the user.

42) A method for providing assistance for a hosted application to an accessor of the hosted application from a support network access device, comprising the steps of:
instantiating an instant messaging client on a network access device being used by the accessor;
instantiating an instant messaging client on a support network access device;
receiving a support request from the accessor network access device, said accessor network access device accessing a hosted application from a remote location, said request being a request for assistance for an on-going hosted application session;
communicating to the support network access device hosted application information using an instant messaging protocol, said hosted application information comprising information for allowing the support network access device to share the ongoing hosted application session; and
instantiating an access to the on-going hosted application session on the support network access device, said access causing the hosted application session to become shared with the support network access device.

43) A method for providing accessor assistance for a hosted application according to claim 42, wherein the hosted application information comprises port identification information, said port identification information comprising identification of at least one port on a hosted application server, said hosted application server hosting the on-going hosted application session.

44) A method for providing accessor assistance for a hosted application according to claim 42, wherein the hosted application information comprises role information, said role information defining the authority of a network access device to interact with a shared hosted application.

45) A method for providing accessor assistance for a hosted application according to claim 44, wherein said role information may be used to alternate control of a shared hosted application session between said accessor network access device and said support network access device.

46) A method for providing accessor assistance according to claim 48, wherein an accessor is associated with the accessor network access device, said accessor having an identity, and wherein said role information is dependant on the identity of the accessor.

47) A method for providing accessor assistance for a hosted application according to claim 42, wherein said hosted application information is masked to prevent said information from being readily discernible by a user of the support network access device.

48) A method for providing customer assistance for a hosted application according to claim 42, wherein said hosted application information is masked to prevent said information from being readily discernible by a user of the accessing network access device.

49) A method for providing accessor assistance for a hosted application according to claim 42, wherein said hosted network application information is encrypted while being communicated to the support network access device.

50) A method for providing accessor assistance for a hosted application according to claim 42, wherein said hosted application information comprises access authorization information.

51) A method for providing accessor assistance for a hosted application according to claim 50, wherein said access authorization information is unique to the support request.

52) A method for providing a hosted application training session, said training session including shared access to a hosted application session between at least one trainer and at least one trainee, said method comprising the steps of:
instantiating a hosted application session from a trainer's network access device, said hosted application session hosted by a remote hosted application server, said trainer's network access device being connected to a communications network, said remote hosted application server also being connected to the network;
instantiating an instant messaging client on the at least one trainer's network access device;
instantiating an instant messaging client on at least one trainee's network access device, said network access device having a trainee's connection to the communications network, said trainee's network connection having a bandwidth;
communicating to the at least one trainee's network access device a capability verification request;
determining whether said at least one trainee's network access device is capable of participating in a shared hosted application training session; and
when it is determined that said at least one trainee's network access device is capable of participating in a shared hosted application session, communicating to the at least one trainee's network access device hosted application information, said hosted application information comprising information allowing the at least one trainee's network access device to share a hosted application training session.

53) A method for providing hosted application information to enable a hosted application training session according to claim 52, wherein said capability verification request comprises application server port information, and wherein said determination of whether said at least one trainee's network access device is capable of participating in a shared hosted application training session comprises determining whether the at least one trainee's network access device is capable of communicating with the hosted application server via the application server port information.

54) A method for providing hosted application information to enable a hosted application training session according to claim 52, wherein performance capabilities of a trainee's network access device affect performance of a shared application training session, said effect being quantifiable as an amount, wherein said determination of whether said at least one trainee's network access device is capable of participating in a shared hosted application training session is dependant on the amount that said at least one trainee's network access device will restrict performance of the shared hosted application session.

55) A method for providing hosted application information to enable a hosted application training session according to claim 54, wherein performance capabilities of a trainee's network access device affect performance of a shared application training session, said effect being quantifiable as an amount, wherein the amount that said at least one trainee's network access device will restrict performance of the shared hosted application session is dependant on the bandwidth of the at least one trainee's network connection.

56) A method for providing hosted application information to enable a hosted application training session according to claim 54, wherein performance capabilities of a trainee's network access device affect performance of a shared application training session, said effect being quantifiable as an amount, wherein the amount that said at least one trainee's network access device will restrict performance of the shared hosted application session is dependant on an ability of the trainee's network access device to display information associated with the hosted application session.

57) A method for providing hosted application information to enable a hosted application training session according to claim 52, wherein said determination of whether said at least one trainee's network access device is capable of participating in a shared hosted application training session comprises determining whether the at least one trainee's network access device has adequate software installed to allow said at least one trainee's network access device to share a hosted application session.

58) A method for providing hosted application information to enable a hosted application training session according to claim 52, wherein the step of communicating to said at least one trainee's network access device a capability verification request occurs in response to a request from the at least one trainee's network access device to participate in a shared hosted application training session.

59) A method for providing hosted application information to enable a hosted application training session according to claim 52, wherein the step of communicating to said at least one trainee's network access device a capability verification request occurs in response to a request from the at least one trainer's network access device to invite a user to participate in a shared hosted application training session.

60) A method for providing hosted application information to enable a hosted application training session according to claim 52, wherein the step of communicating to said at least one trainee's network access device a capability verification request further comprises masking the capability verification request such that it is not readily discernible to a user of said at least one trainee's network access device.

61) A method for providing hosted application information to enable a hosted application training session according to claim 52, wherein the step of communicating to said at least one trainee's network access device a capability verification request further comprises the step of encrypting the capability verification request prior to communicating the capability verification request to said at least one trainee's network access device.

62) A method for providing hosted application information to enable a hosted application training session according to claim 52, wherein the step of communicating to said at least one trainee's network access device hosted application information further comprises masking the hosted application information such that it is not readily discernible to a user of said at least one trainee's network access device.

63) A method for providing hosted application information to enable a hosted application training session according to claim 52, wherein the step of communicating to said at least one trainee's network access device hosted application information further comprises the step of encrypting the hosted application information prior to communicating the capability verification request to said at least one trainee's network access device.

64) A method for providing hosted application information to enable a hosted application training session according to claim 52, wherein said hosted application information for allowing said at least one trainee's network access device to share a hosted application training session further comprises role information, said role information defining authority of a network access device to interact with a shared hosted application training session.

65) A method for providing hosted application information to enable a hosted application training session according to claim 64, wherein said role information is used to alternate control of a shared hosted application session between a trainer's network access device and a trainee's network access device.

66) A method for communicating hosted application information to allow sharing of a hosted application session according to claim 64, wherein at least one trainee is associated with said at least one trainee's network access device, said at least one trainee having an identity, and wherein authority associated with said role information is dependant on the identity of the at least one trainee.

67) A method for communicating hosted application information to allow sharing of a hosted application session according to claim 64, wherein at least one trainer is associated with said at least one trainer's network access device, said at least one trainer having an identity, and wherein authority associated with said role information is dependant on the identity of the at least one trainer.

68) A method for providing a shared hosted application session, wherein said session is shared among a plurality of shared hosted application participants; comprising the steps of:
instantiating a hosted application session on a first network access device associated with a first application participant, said hosted application session being hosted by an application hosting server;
instantiating an instant messaging client on said first network access device;
using said instant messaging client to establish a communications path to at least a second network access device associated with at least a second participant, said second network access device having a second connection to the network, said second network connection having a bandwidth;
communicating to said at least second network access device a capability verification request;
determining whether said second network access device is capable of participating in a shared hosted application session;
when it is determined that said second network access device is capable of participating in a shared hosted application session, communicating to the at least second participant via the communications path an invitation to share the hosted application session;
when it is determined that said second network access device is capable of participating in a shared hosted application session, determining whether the at least second participant desires to participate in a shared hosted application session;
when it is determined that said second network access device is capable of participating in a shared hosted application session and that said at least second participant desires to participate in a shared hosted application session, communicating to said second network access device hosted application information, said hosted application information for allowing said second network access device to share a hosted application session; and
when it is determined that said second network access device is capable of participating in a shared hosted application session and that said at least second participant desires to participate in a shared hosted application session, instantiating an access to the shared application session on said at least second network access device in accordance with the communicated hosted application information.

69) A method for providing a shared hosted application session according to claim 68, wherein said capability verification request comprises application server port information, and wherein said determination of whether said second network access device is capable of participating in a shared hosted application session comprises determining whether said second network access device is capable of communicating with the hosted application server via the application server port information.

70) A method for providing a shared hosted application session according to claim 68, wherein performance capabilities of a network access device affect performance of a shared application session, said effect being quantifiable as an amount, wherein said determination of whether said second network access device is capable of participating in a shared hosted application session is dependant on the amount that said second network access device will restrict performance of the shared hosted application session.

71) A method for providing a shared hosted application session according to claim 70, wherein the amount that said second network access device will restrict performance of the shared hosted application session is dependant on the bandwidth of the second network connection.

72) A method for providing a shared hosted application session according to claim 70, wherein the amount that said second network access device will restrict performance of the shared hosted application session is dependant on an ability of the second network access device to display information associated with the hosted application session.

73) A method for providing a shared hosted application session according to claim 68, wherein said determination of whether said second network access device is capable of participating in a shared hosted application session comprises determining whether said second network access device has adequate software installed to allow said second network access device to participate in a shared hosted application session.

74) A method for providing a shared hosted application session according to claim 68, wherein the step of communicating to said second network access device a capability verification request further comprises masking the capability verification request such that it is not readily discernible to said second participant.

75) A method for providing a shared hosted application session according to claim 68, wherein the step of communicating to said second network access device a capability verification request further comprises the step of encrypting the capability verification request prior to communicating the capability verification request to said second network access device.

76) A method for providing a shared hosted application session according to claim 68, wherein the step of communicating to said second network access device hosted application information further comprises masking the hosted application information such that it is not readily discernible to said second participant.

77) A method for providing a shared hosted application session according to claim 68, wherein the step of communicating to said second network access device hosted application information further comprises the step of encrypting the hosted application information prior to communicating the hosted application information to said second network access device.

78) A method for providing a shared hosted application session according to claim 68, wherein the step of communicating hosted application information to said second network access device further comprises the step of communicating the hosted application to the second network access device from the first network access device, the method further comprising the step of masking the hosted application information such that it is not readily discernible to a user of said first network access device.

79) A method for providing a shared hosted application session according to claim 68, wherein the step of communicating hosted application information to said second network access device further comprises the step of communicating the hosted application to the first network access device before the hosted application information is communicated to the second network access device, and wherein the step of communicating hosted application information to said first network access device further comprises the step of encrypting the hosted application information prior to communicating the hosted application information to said first network access device.

80) A method for providing a shared hosted application session according to claim 68, wherein said hosted application information for allowing said second network access device to share a hosted application session further comprises role information, said role information defining the authority of said second network access device to interact with a shared hosted application session.

81) A method for providing a shared hosted application session according to claim 80, wherein said role information is used to alternate control of a shared hosted application session between said first network access device and said second network access device.

82) A method for providing a shared hosted application session according to claim 80, wherein said second participant has an identity, and wherein said role information is dependant on said identity.

83) A computer-readable medium tangibly embodying instructions which, when executed by a network access device, implement a process comprising the steps of:
causing an instant messaging service to be instantiated on a first network access device, said first network access device having a first network connection to a network;
causing the instantiated instant messaging service to establish a communications path with a remote network access device, said remote network access device having a second network connection to a the network;
receiving at the first network access device a capability verification request;
determining whether the first network access device meets capability requirements, said capability requirements identified in the capability verification request;
communicating to the remote network access device whether the first network access device meets capability requirements;
when the first network access device meets capability requirements, receiving at the first network access device hosted application information; and
when said hosted application information indicates an available hosted application, attempting to establish a hosted application session with the available hosted application.

84) A computer-readable medium tangibly embodying instructions according to claim 83, wherein said capability verification request comprises application server port information, and wherein said determination of whether the first network access device meets capability requirements comprises determining whether the first network access device is capable of communicating with a hosted application server via the application server port information.

85) A computer-readable medium tangibly embodying instructions according to claim 84, wherein performance capabilities of said first network access device affect performance of a shared hosted application session, said affect being quantifiable as an amount, and wherein said determination of whether the first network access device meets capability requirements is dependant on the amount that said first network access device will restrict performance of a shared hosted application session.

86) A computer-readable medium tangibly embodying instructions according to claim 85, wherein the amount that said first network access device will restrict performance of a shared hosted application session is dependant on the bandwidth of the first network connection.

87) A computer-readable medium tangibly embodying instructions according to claim 85, said first network access device having a capability to display information associated with a hosted application session, wherein the amount that said first network access device will restrict performance of a shared hosted application session is dependant on said capability of the first network access device to display information associated with a hosted application session.

88) A computer-readable medium tangibly embodying instructions according to claim 83, wherein said determination of whether said first network access device is capable of participating in a shared hosted application training session comprises determining whether said first network access device has adequate software installed to allow said first network access device to share a hosted application session.

89) A computer-readable medium tangibly embodying instructions according to claim 83, said instructions implementing a process further comprising the step of decrypting hosted application information when received hosted application information is encrypted.

90) A computer-readable medium tangibly embodying instructions according to claim 83, said instructions implementing a process further comprising the step of receiving role information, said role information identifying the authority of the network access device to interact with a shared hosted application session.

91) A computer readable medium tangibly embodying instructions according to claim 83, said instructions implementing a process further comprising the step of controlling interaction between a computer executing the process and a shared hosted application.

92) A computer readable medium tangibly embodying instructions according to claim 91, wherein the step of controlling interaction is dependant on an identity associated with a user of the computer executing the process.

93) A computer readable medium tangibly embodying instructions according to claim 91, wherein said hosted application information comprises role information, and the step of controlling interaction is dependant on said role information.
